(19) United States
(12) Patent Application Publication
(10) Pub. No.: US 2012/0109718 A1
(43) Pub. Date: May 3, 2012

(54) System and Method for What-If Analysis of a University Based on Their University Model Graph

(75) Inventors: Sridhar Varadarajan, Bangalore (IN); Srividya Gopalan, Bangalore (IN); Preethy Iyer, Bangalore (IN); Amit Thawani, Bangalore (IN)

(73) Assignee: SRM INSTITUTE OF SCIENCE AND TECHNOLOGY, West Mambalam (IN)

(21) Appl. No.: 13/025,325

(22) Filed: Feb. 11, 2011

(30) Foreign Application Priority Data
Oct. 28, 2010 (IN) 3203/CHE/2010

(51) Int. Cl. G06Q 10/00

(52) U.S. Cl. 705/7.37

(57) ABSTRACT

An educational institution (also referred as a university) is structurally modeled using a university model graph. A key benefit of modeling of the educational institution is to help in an introspective analysis by the educational institute. Specifically, the model is quite beneficial for undertaking the analysis of the various issues faced by the educational institute. A what-if scenario requires the model to be suitably changed to address the issue under consideration and the changed model needs to be analyzed to determine how the issue could be handled. A system and method for what-if scenario analysis based on the university model graph is discussed.

1. A reference is made to the applicants' earlier Indian patent application titled “System and Method for an Influence based Structural Analysis of a University” with the application number 1269/CHE2010 filed on 6 May 2010.

2. A reference is made to another of the applicants' earlier Indian patent application titled “System and Method for Constructing a University Model Graph” with an application number 1809/CHE/2010 and filing date of 28 Jun., 2010.

3. A reference is made to yet another of the applicants' earlier Indian patent application titled “System and Method for University Model Graph based Visualization” with the application number 1848/CHE/2010 dated 30 Jun. 2010.

### FIELD OF THE INVENTION

The present invention relates to the analysis of the information about a university in general, and more particularly, the analysis of the university based on the structural representations. Still more particularly, the present invention relates to a system and method for what-if analysis based on a model graph associated with the university.

### BACKGROUND OF THE INVENTION

A what-if analysis is typically a hypothetical analysis in which the parameters of a system being analyzed are hypothetically changed so as to determine the new system behavior. Such an analysis helps in determining what happens if the system parameters change in a particular manner. Again, typically, this is done in a simulated environment that uses a model of the system being what-if analyzed. What-if analysis is common and has been used to obtain practical insights in many domains: financial, industrial, process, and business domains to name just a few.

An Educational Institution (EI) (also referred as University) comprises of a variety of entities: students, faculty members, departments, divisions, labs, libraries, special interest groups, etc.

University portals provide information about the universities and act as a window to the external world. A typical portal of a university provides information related to (a) Goals, Objectives, Historical Information, and Significant Milestones, of the university; (b) Profile of the Labs, Departments, and Divisions; (c) Profile of the Faculty Members; (d) Significant Achievements; (e) Admission Procedures; (f) Information for Students; (g) Library; (h) On- and Off-Campus Facilities; (i) Research; (j) External Collaborations; (k) Information for Collaborators; (I) News and Events; (m) Alumni; and (n) Information Resources. The educational institutions are positioned in a very competitive environment and it is a constant endeavor of the management of the educational institution to ensure to be ahead of the competition. This calls for a critical analysis of the overall functioning of the university and help suggest improvements so as enhance the overall strength aspects and overcome the weaknesses. Consider as a typical scenario involving an allocation of funds to the various laboratories of the institution: it makes sense to allocate funds to those labs that provide opportunities for more faculty members to undertake their research work; this in turn would involve more students as research assistants; this double headed improvement leads to the overall enhanced assessment of the institution. Similarly, consider a scenario of enhancing the overall assessment of a faculty member: in this case, encouraging the faculty member to attend a technical conference and present their work would help enhance the influencing factors with respect to both peer faculty members and students. These illustrative scenarios call for what-if analysis based on a model of the institution to obtain better and practical insights into the institution.

### DESCRIPTION OF RELATED ART

U.S. Pat. No. 7,606,165 to Qiu; Lili (Bellevue, Wash.), Bahl; Paramvir (Sammamish, Wash.), Zhou; Lidong (Sunnyvale, Calif.), Rao; Ananth Rajagopala (El Cerrito, Calif.) for “What-if analysis for network diagnostics” (issued on Oct. 20, 2009 and assigned to Microsoft Corporation (Redmond, Wash.)) describes a network troubleshooting framework for performing what-if analysis of wired and wireless networks.

United States Patent Application 20100198958 titled “Real-Time Feedback for Policies for Computing System Management” by Cannon; David M.; (Tucson, Ariz.); Humphries; Marshall L.; (Tucson, Ariz.) (filed on Apr. 14, 2010 and assigned to International Business Machines Corporation, Armonk, N.Y.) describes a method for providing real-time feedback regarding the effect of applying a policy definition used for management in a computing system.

“Adding Change Impact Analysis to the Formal Verification of C Programs” by Autexier; Serge and Luth; Christoph (appeared in Dominique Mery and Stephan Merz (Eds.), Proceedings 8th

International Conference on integrated Formal Methods (IFM2010), LNCS, Nancy, France, Springer, October, 2010) describes a framework based on document graph model to handle changes to programs and specifications efficiently as part of formal software verification.

“Modularity-Driven Clustering of Dynamic Graphs” by Gorke; Robert, Maillard; Pascal, Staudt; Christian, and Wagner; Dorothea (appeared in Experimental Algorithms, Lecture Notes in Computer Science, 2010, Volume 6049/2010, 436-448) describes graph analysis algorithms for efficiently maintaining a modularity based clustering of a graph that changes dynamically.

“A Graph-Theory Framework for Evaluating Landscape Connectivity and Conservation Planning” by Minor; Emily and Urban; Dean (appeared in Conservation Biology (Wiley-Blackwell), Volume 22, Issue 2, Pages 297-307, April 2008) describes a graph-theoretic approach to characterize multiple aspects of landscape connectivity in a habitat network and uses the notions of graph measures such as compartmentalization and clustering for the purposes of analysis.

The known systems do not address the issue of what-if analysis based on a comprehensive modeling of an educational institution at various levels in order to be able to provide for introspective analysis. The present invention provides for a system and method for what-if analysis based on a university model graph of the educational institution.

### SUMMARY OF THE INVENTION

The primary objective of the invention is to achieve what-if analysis based on a university model graph (UMG) associated with an educational institution to help the educational institution in an introspective analysis.

One aspect of the present invention is to analyze a what-if analysis request and to derive a revised optimized university model graph.

Another aspect of the present invention is to interpret the revised optimized university model graph and generate recommendations.

Yet another aspect of the present invention is to find an optimal sub-UMG based on the university model graph.

Another aspect of the present invention is to minimally change to tune the university model graph so as achieve the set base scores of the select nodes of the university model graph.

Yet another aspect of the present invention is to determine the best set of entities and entity-instances among a few sets based on the university model graph.

Another aspect of the present invention is to select a sub-UMG and tune the sub-UMG.

Yet another aspect of the invention is to achieve the tuning of the university model graph based on a set of influence values.

Another aspect of the present invention is to achieve combining of two or more university model graphs.
In a preferred embodiment the present invention provides a system for the what-if analysis of a plurality of what-if requests based on a university model graph (UMG) of a university to generate a plurality of recommendations based on a plurality of assessments and a plurality of influence values contained in a university model graph database to help in undertaking introspective analysis of said university, said university having a plurality of entities and a plurality of entity-instances,
wherein each of said plurality of entity-instances is an instance of an entity of said plurality of entities, and said university model graph having a plurality of models, a plurality of abstract nodes, a plurality of nodes, a plurality of abstract edges, a plurality of semi-abstract edges, and a plurality of edges,
with each abstract node of said plurality of abstract nodes corresponding to an entity of said plurality of entities,
each node of said plurality of nodes corresponding to an entity-instance of said plurality of entity-instances, and
each abstract node of said plurality of abstract nodes is associated with a model of said plurality of models, and
a node of said plurality of nodes is connected to an abstract node of said plurality of abstract nodes through an abstract edge of said plurality of abstract edges, wherein said node represents an instance of an entity associated with said abstract node and said node is associated with an instantiated model and a base score, wherein said instantiated model is based on a model associated with said abstract node, and said base score is computed based on said instantiated model and is a value between 0 and 1,
a source abstract node of said plurality of abstract nodes is connected to a destination abstract node of said plurality of abstract nodes by a directed abstract edge of said plurality of abstract edges and said directed abstract edge is associated with an entity influence value of said plurality of influence values, wherein said entity influence value is a value between −1 and +1;
a source node of said plurality of nodes is connected to a destination node of said plurality of nodes by a directed edge of said plurality of edges and said directed edge is associated with an influence value of said plurality influence values, wherein said influence value is a value between −1 and +1;
a source node of said plurality of nodes is connected to a destination abstract node of said plurality of abstract nodes by a directed semi-abstract edge of said plurality of semi-abstract edges and said directed semi-abstract edge is associated with an entity-instance-entity-influence value of said plurality influence values, wherein said entity-instance-entity-influence value is a value between −1 and +1; and
a source abstract node of said plurality of abstract nodes is connected to a destination node of said plurality of nodes by a directed semi-abstract edge of said plurality of semi-abstract edges and said directed semi-abstract edge is associated with an entity-entity-instance-influence value of said plurality influence values, wherein said entity-entity-instance-influence value is a value between −1 and +1, said system comprising,
   means for deriving of a revised optimized university model graph based on a what-if request of said plurality of what-if requests and said UMG; and
   means for generating of a recommendation of said plurality of recommendations based on said revised optimized university model graph;
   wherein said means for deriving of said revised optimized university model graph further comprises of:
   means for generating of an optimal sub-UMG based on said UMG and assigning of said optimal sub-UMG as said revised optimized university model graph;
   means for generating of a tuned UMG based on said UMG and a plurality of select nodes, wherein each select node of said plurality of select nodes is a part of said plurality of abstract nodes or a part of said plurality of bodes, and is associated with an expected base score, and assigning of said tuned UMG as said revised optimized university model graph;
   means for selecting of a best set of a plurality of sets based on said UMG, wherein each set of said plurality of sets comprises of a plurality of selected abstract nodes of said plurality of abstract nodes and a plurality of selected nodes of said plurality of nodes, and assigning of said best set as said revised optimized university model graph;
   means for local analysis of said UMG to generate a local sub-UMG;
   means for generating of a tuned sub-UMG based on said local sub-UMG, and assigning of said tuned sub-UMG as said revised optimized university model graph;
   means for selecting of a local best set of a plurality of local sets based on said local sub-UMG, wherein each set of said plurality of local sets comprises of a plurality of selected abstract nodes of said plurality of abstract nodes and a plurality of selected nodes of said plurality of nodes, and assigning of said best set as said revised optimized university model graph;
   means for generating of an influence tuned UMG based on said UMG and a plurality of select node pairs, wherein a node pair of said plurality of node pairs comprises of a node 1 of said node pair is a part of said plurality of abstract nodes or said plurality of nodes, a node 2 of said node pair is a part of said plurality of abstract nodes or said plurality of nodes, and assigning of said influence tuned UMG as said revised optimized university model graph;
   means for generating of an influence tuned UMG 2 based on said UMG, and assigning of said influence tuned UMG 2 as said revised optimized university model graph; and
   means for combining of a plurality of additional university model graphs and said UMG to generate a combined UMG, and assigning of said combined UMG as said revised optimized university model graph.

### BRIEF DESCRIPTION OF THE DRAWINGS

FIG. 1 provides an overview of EI Analysis System.

FIG. 1A provides an illustrative University Model Graph.

FIG. 1B provides the elements of University Model Graph.

FIG. 2 provides a Partial List of Entities of a University.

FIG. 3 provides illustrative What-If Scenarios.

FIG. 4 provides illustrative Recommendations.

FIG. 4A provides additional illustrative Recommendations.

FIG. 5 provides an overview of Generic UMG Analysis Techniques.

FIG. 6 provides an overview of Approach for Technique 1.

FIG. 6A provides an Approach for Technique 1.

FIG. 7 provides an Approach for Technique 2.

FIG. 8 provides an Approach for Technique 3.

FIG. 9 provides an Approach for Technique 4.

FIG. 10 provides an Approach for Technique 5.

FIG. 10A provides additional information on Approach for Technique 5.

FIG. 11 provides an Approach for Technique 6.

FIG. 12 provides an overview of Generating Recommendations.

FIG. 12A provides additional information related to Generating of Recommendations.

FIG. 12B provides more information related to Generating of Recommendations.

FIG. 12C provides further more information related to Generating of Recommendations.

FIG. 13 provides an illustrative UMG for Analysis.

FIG. 13A provides an illustrative Analysis Result related to Tuning of UMG.

### DETAILED DESCRIPTION OF THE PREFERRED EMBODIMENTS

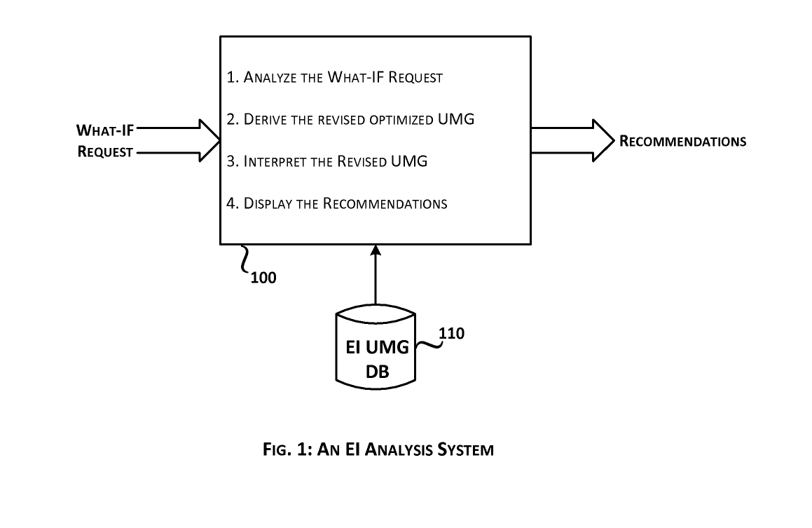

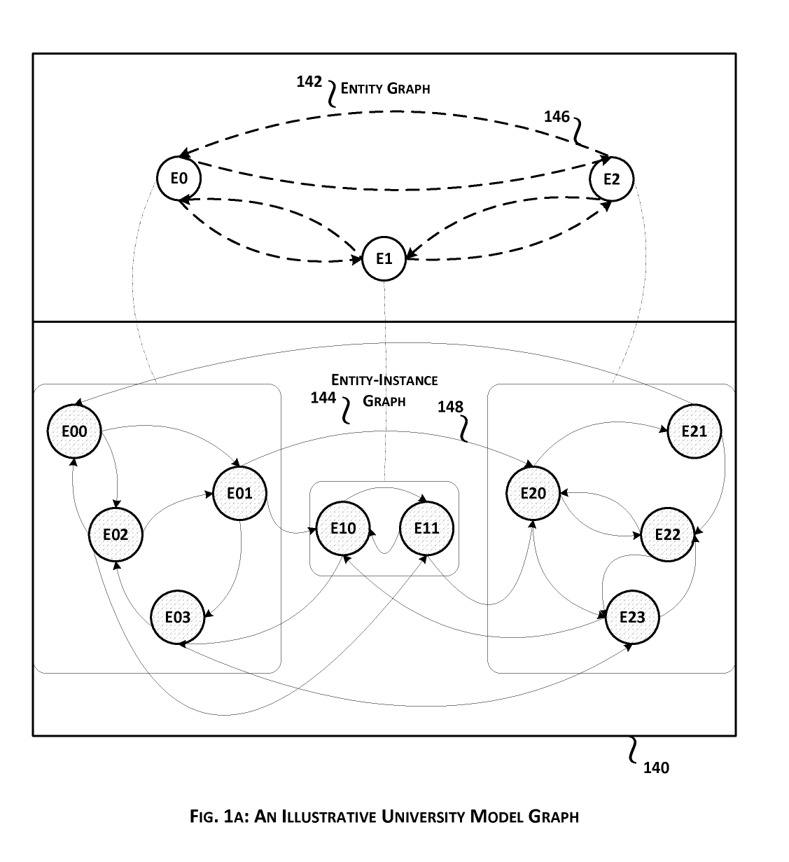

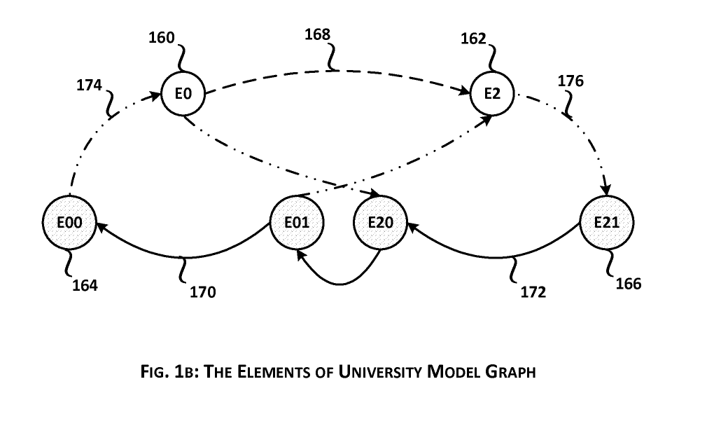

FIG. 1 provides an overview of El Analysis System. The system (100) allows for what-if analysis and introspective analysis of a university and the means to achieve the same is as follows: to analyze the what-if request, based on the request, appropriately modify the university model graph associated with the university, interpret the modified university model graph to generate appropriate recommendations. The system takes a What-If request as input and generates recommendations to achieve, say, greater operational efficiency based on the database comprising of UMG data (110).

FIG. 1a depicts an illustrative University Model Graph. 140 describes UMG as consisting of two main components: Entity Graph (142) and Entity-Instance Graph (144). Entity graph consists of entities of the university as its nodes and an abstract edge (146) or abstract link is a directed edge that connects two entities of the entity graph. Note that edge and link are used interchangeably. The weight associated with this abstract edge is the influence factor or influence value indicating nature and quantum of influence of the source entity on the destination entity. Again, influence factor and influence value are used interchangeably. Similarly, the nodes in the entity-instance graph are the entity instances and the edge (148) or the link between two entity-instances is a directed edge and the weight associated with the edge indicates the nature and quantum of influence of the source entity-instance on the destination entity-instance.

FIG. 1b provides the elements of a University Model Graph. The fundamental elements are nodes and edges. There are two kinds of nodes: Abstract nodes (160 and 162) and Nodes (164 and 166); There are three kinds of directed edges or links: Abstract links (168), links (170 and 172), and semi-abstract links (174 and 176). As part of the modeling, the abstract nodes are mapped onto entities and nodes are mapped onto the instances of the entities; Each node is associated with an entity-specific instantiated model and a node score that is a value between 0 and 1 is based on the entity-specific instantiated model; This score is called as Base Score; the weight associated with an abstract link corresponds to an entity influence value (EI-Value), the weight associated with a semi-abstract link corresponds to either an entity-entity-instance influence value (EIEI-Value) or an entity-instance-entity influence value (IEEI-Value), and finally, the weight associated with a link corresponds to an entity-instance influence value (I-Value). Note that edges and links are used interchangeably. Further, each entity is associated with a model and an instance of an entity is associated with a base score and an instantiated model, wherein the base score is computed based on the associated instantiated model and denotes the assessment of the entity instance. The weight associated with a directed edge indicates the nature and quantum of influence of the source node on the destination node and is a value between −1 and +1; This weight is called as Influence Factor.

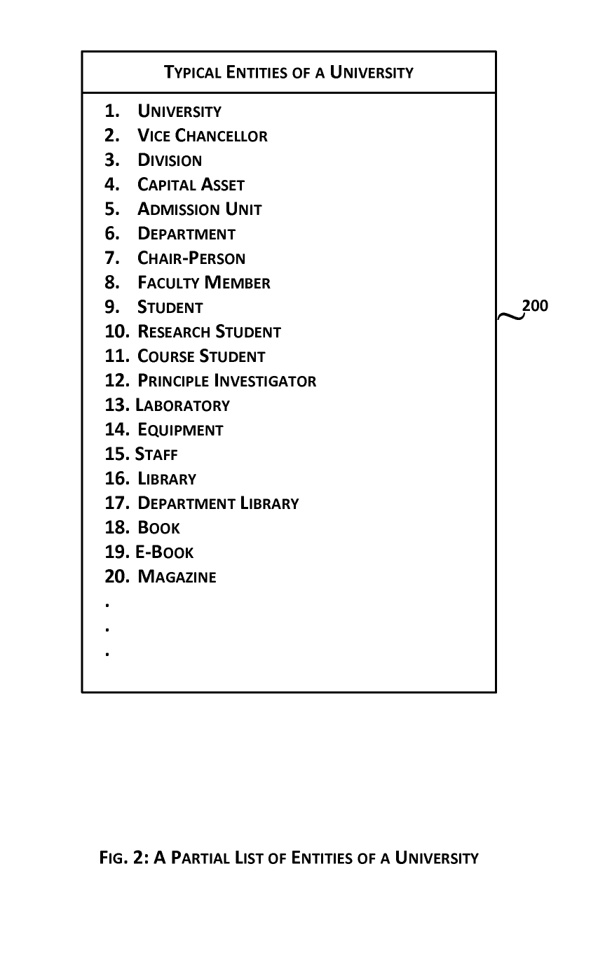

FIG. 2 depicts a partial list of entities of a university. Note that a deep domain analysis would uncover several more entities and also their relationship with the other entities (200). For example, RESEARCH STUDENT is a STUDENT who is a part of a DEPARMENT and works with a FACULTY MEMBER in a LABORATORY using some EQUIPEMENT, the DEPARMENT LIBRARY, and the LIBRARY.

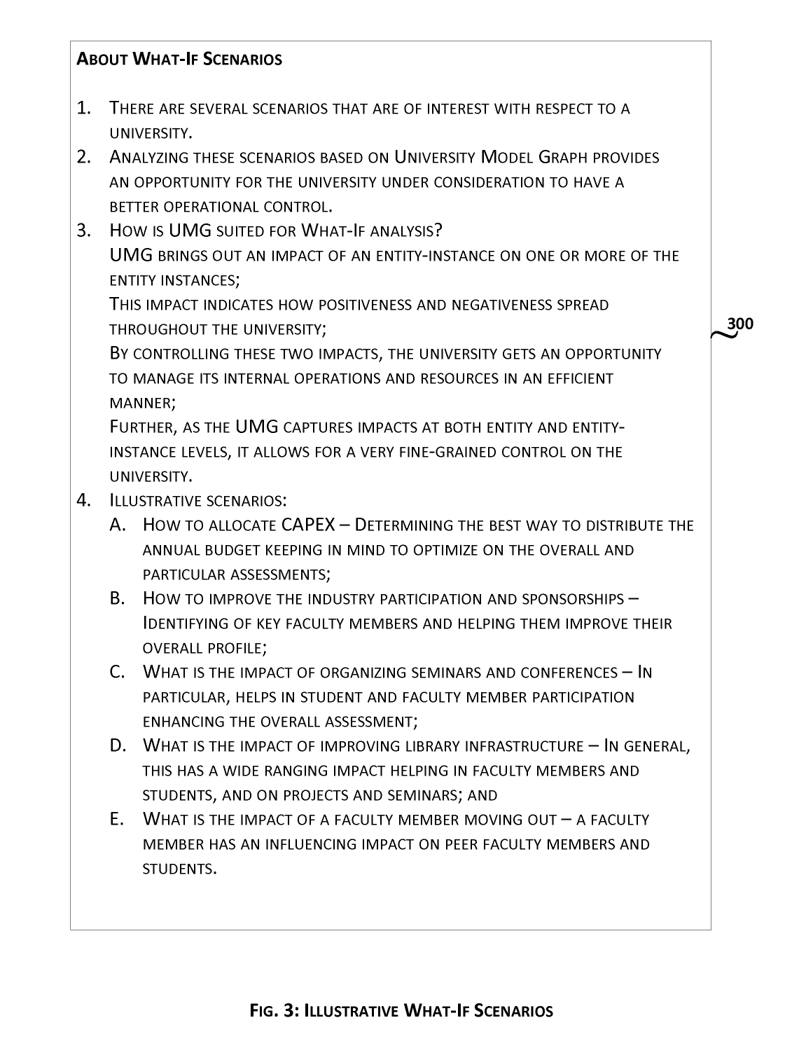

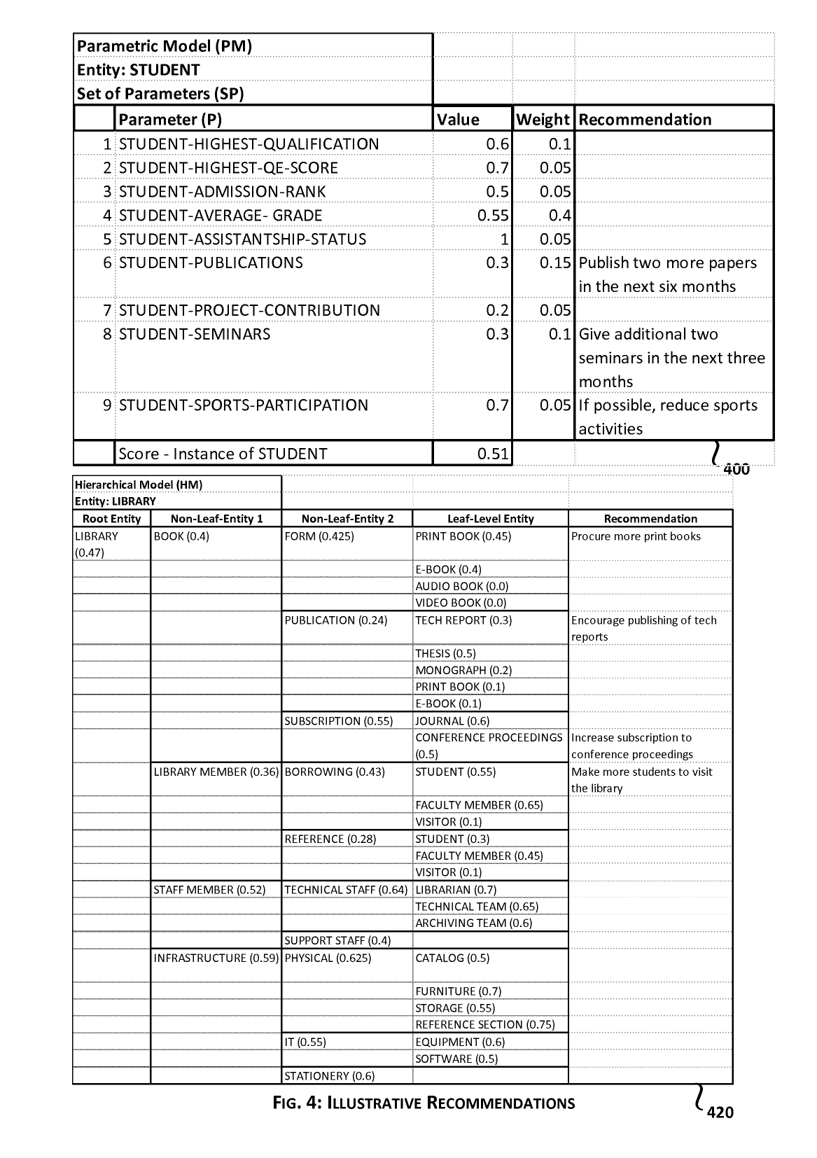

FIG. 3 provides illustrative What-If Scenarios.

About What-If Scenarios (300):

1. There are several scenarios that are of interest with respect to a university.
2. Analyzing these scenarios based on University Model Graph provides an opportunity for the university under consideration to have a better operational control.
3. How is UMG suited for What-If analysis?

UMG brings out an impact of an entity-instance on one or more of the entity instances;

This impact indicates how positiveness and negativeness spread throughout the university;

By controlling these two impacts, the university gets an opportunity to manage its internal operations and resources in an efficient manner;

Further, as the UMG captures impacts at both entity and entity-instance levels, it allows for a very fine-grained control on the university.

4. Illustrative scenarios:

A. How to allocate CAPEX—Determining the best way to distribute the annual budget keeping in mind to optimize on the overall and particular assessments;

B. How to improve the industry participation and sponsorships—Identifying of key faculty members and helping them improve their overall profile;

C. What is the impact of organizing seminars and conferences—In particular, helps in student and faculty member participation enhancing the overall assessment;

D. What is the impact of improving library infrastructure—In general, this has a wide ranging impact helping in faculty members and students, and on projects and seminars; and

E. What is the impact of a faculty member moving out—a faculty member has an influencing impact on peer faculty members and students.

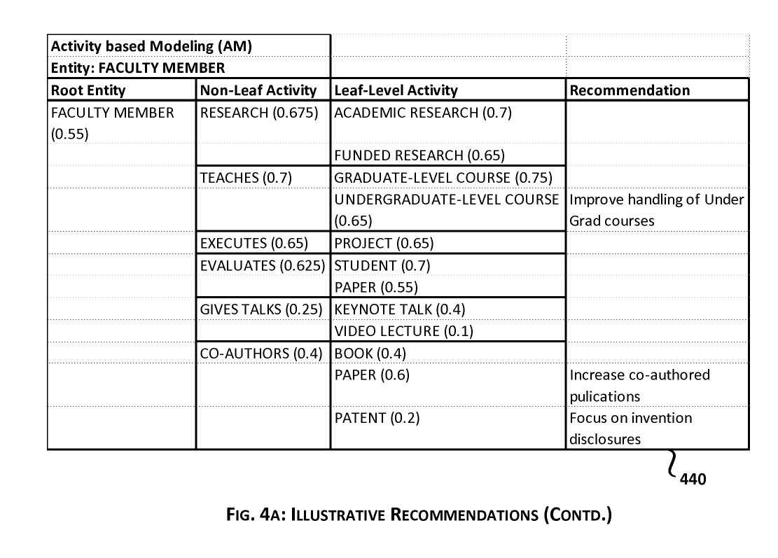

FIG. 4 provides illustrative Recommendations.

400 provides an illustrative parametric model of STUDENT entity. Note that the generated recommendations are based on parameter values where there seems to be a scope for improvement. The computations are illustrative in nature with the overall score arrived based on the weighted summation.

Similarly, 420 provides a few recommendations based on a hierarchical model associated with LIBRARY entity. Please note that the computations are for illustrative purposes and combined as a weighted summation at each level in the hierarchy.

FIG. 4A provides additional illustrative Recommendations.

Again, 440 provides a few recommendations based on an activity based model associated with FACULTY MEMBER entity. Please note that the computations are for illustrative purposes and combined as a weighted summation at each level in the activity hierarchy.

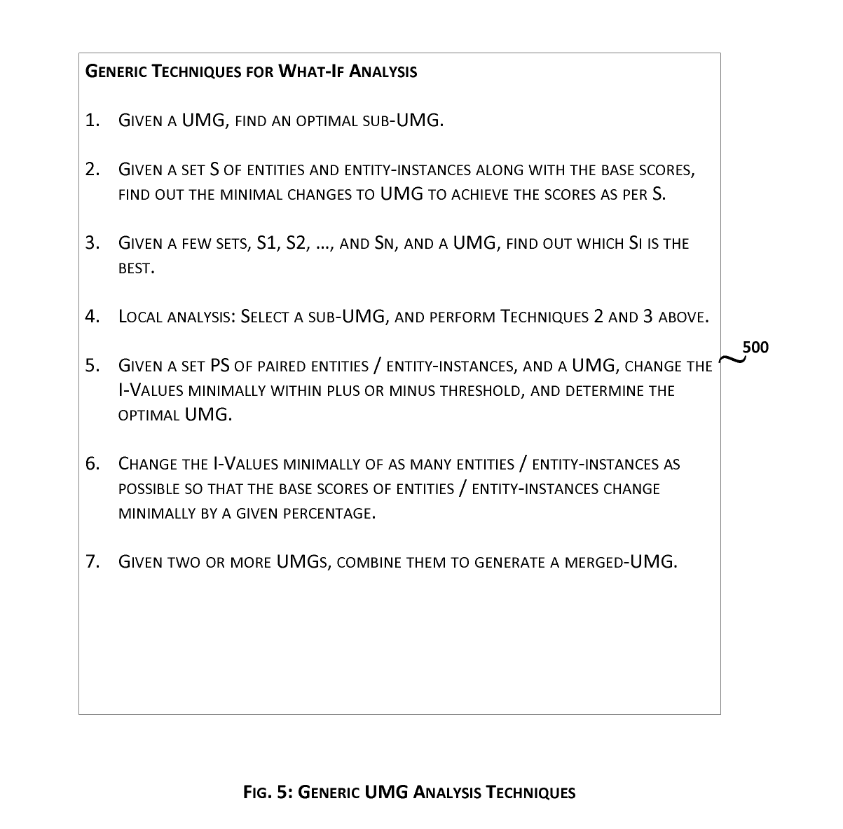

FIG. 5 provides an overview of Generic UMG Analysis Techniques.

Means for (analysis of a what-if request) Generic Techniques for What-If Analysis (500):
1. Given a UMG, find an optimal sub-UMG.
2. Given a set S of entities and entity-instances along with the base scores, find out the minimal changes to UMG to achieve the scores as per S.
3. Given a few sets, S1, S2, . . . , and Sn, and a UMG, find out which Si is the best.
4. Local analysis: Select a sub-UMG, and perform Techniques 2 and 3 above.
5. Given a set PS of paired entities/entity-instances, and a UMG, change the I-Values minimally within plus or minus threshold, and determine the optimal UMG.
6. Change the I-Values minimally of as many entities/entity-instances as possible so that the base scores of entities/entity-instances change minimally by a given percentage.
7. Given two or more UMGs, combine them to generate a merged-UMG.

These techniques play an important role in the analysis and processing of a what-if request.

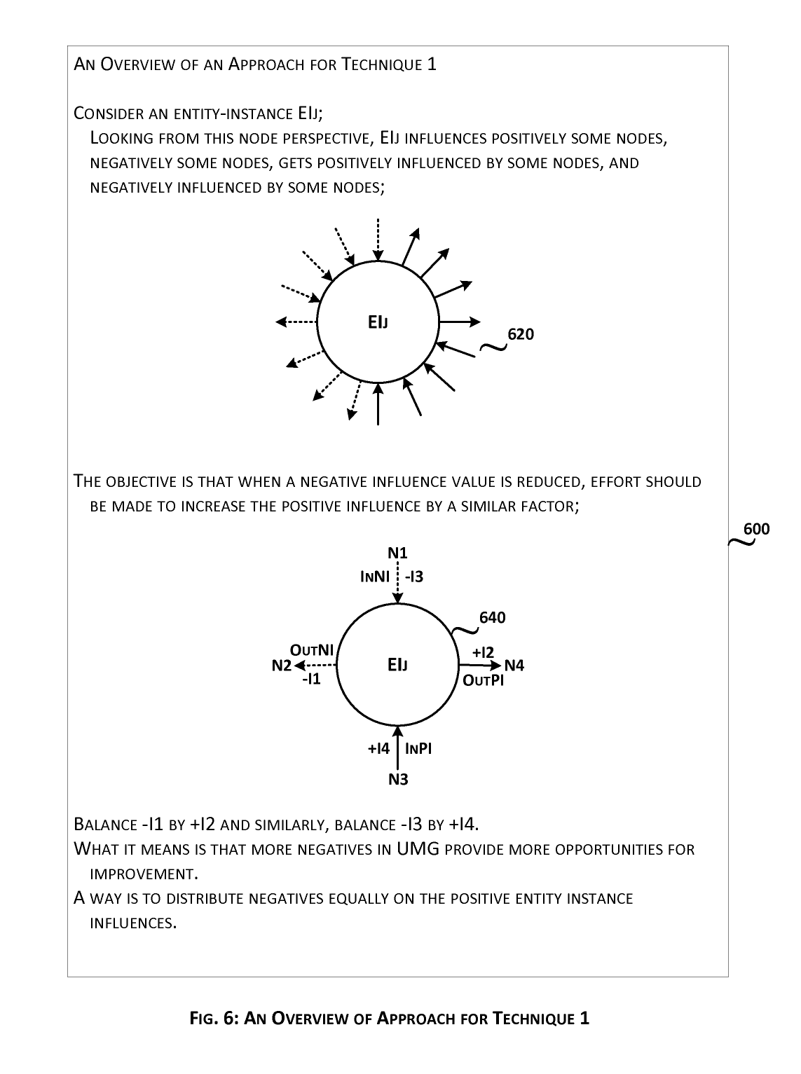

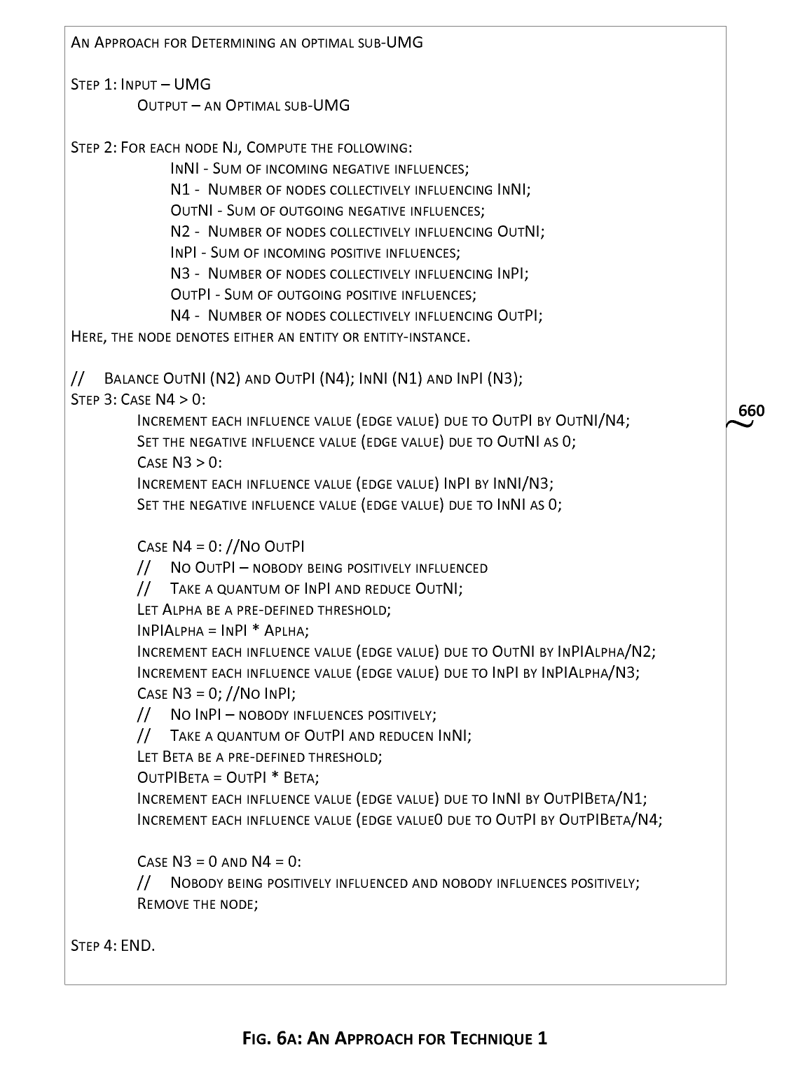

FIG. 6 provides an overview of Approach for Technique 1.

### Means for an Overview of an Approach for Technique 1 (600):

Consider an entity-instance EIj;

Looking from this node perspective, EIj influences positively some nodes, negatively some nodes, gets positively influenced by some nodes, and negatively influenced by some nodes;

As depicted in 620, the node EIj has influences shown by arrow marks: Dotted incoming arrows indicate negative incoming influences, dotted outgoing arrows indicate negative outgoing influences, thick incoming arrows indicate positive incoming influences, and thick outgoing arrows indicate positive outgoing influences.

The objective is that when a negative influence value is reduced, effort should be made to increase the positive influence by a similar factor.

As described above, there are four distinct cumulative influence values (640): N1 nodes negatively influence EIj with an aggregated value of InNI and this value is denoted by −I3; Similarly, EIj influences N2 nodes negatively with an aggregated value of OutNI and this value is denoted by −I1; N3 nodes positively influence EIj with an aggregated value of InPI and this value is denoted by +I4; and, EIj influences N4 nodes positively with an aggregated value of OutPI and this value is denoted by +I2.

Balance −I1 by +I2 and similarly, balance −I3 by +I4.

What it means is that more negatives in UMG provide more opportunities for improvement.

A way is to distribute negatives equally on the positive entity instance influences.

FIG. 6A provides an Approach for Technique 1.

Means for an approach for determining an optimal sub-UMG (660):

### Step 1: Input—UMG

Output—an Optimal sub-UMG

Step 2: For each node Nj, Compute the following:

InNI—Sum of incoming negative influences;

N1—Number of nodes collectively influencing InNI;

OutNI—Sum of outgoing negative influences;

N2—Number of nodes collectively influencing OutNI;

InPI—Sum of incoming positive influences;

N3—Number of nodes collectively influencing InPI;

OutPI—Sum of outgoing positive influences;

N4—Number of nodes collectively influencing OutPI;

Here, the node denotes either an entity or entity-instance.

### // Balance OutNI (N2) and OutPI (N4); InNI (N1) and InPI (N3);

### Step 3: Case N4>0:

Increment each influence value (edge value) due to OutPI by OutNI/N4;

Set the negative influence value (edge value) due to OutNI as 0;

Case N3>0:

Increment each influence value (edge value) InPI by InNI/N3;

Set the negative influence value (edge value) due to InNI as 0;

Case N4=0: //No OutPI

// No OutPI—nobody being positively influenced

// Take a quantum of InPI and reduce OutNI;

Let Alpha be a pre-defined threshold;

InPIAlpha=InPI*Aplha;

Increment each influence value (edge value) due to OutNI by InPIAlpha/N2;

Increment each influence value (edge value) due to InPI by InPIAlpha/N3

Case N3=0; //No InPI;

// No InPI—nobody influences positively;

// Take a quantum of OutPI and reducen InNI;

Let Beta be a pre-defined threshold;

OutPIBeta=OutPI*Beta;

Increment each influence value (edge value) due to InNI by OutPIBeta/N1;

Increment each influence value (edge value0 due to OutPI by OutPIBeta/N4;

Case N3=0 and N4=0:

// Nobody being positively influenced and nobody influences positively;

Remove the node;

### Step 4: END.

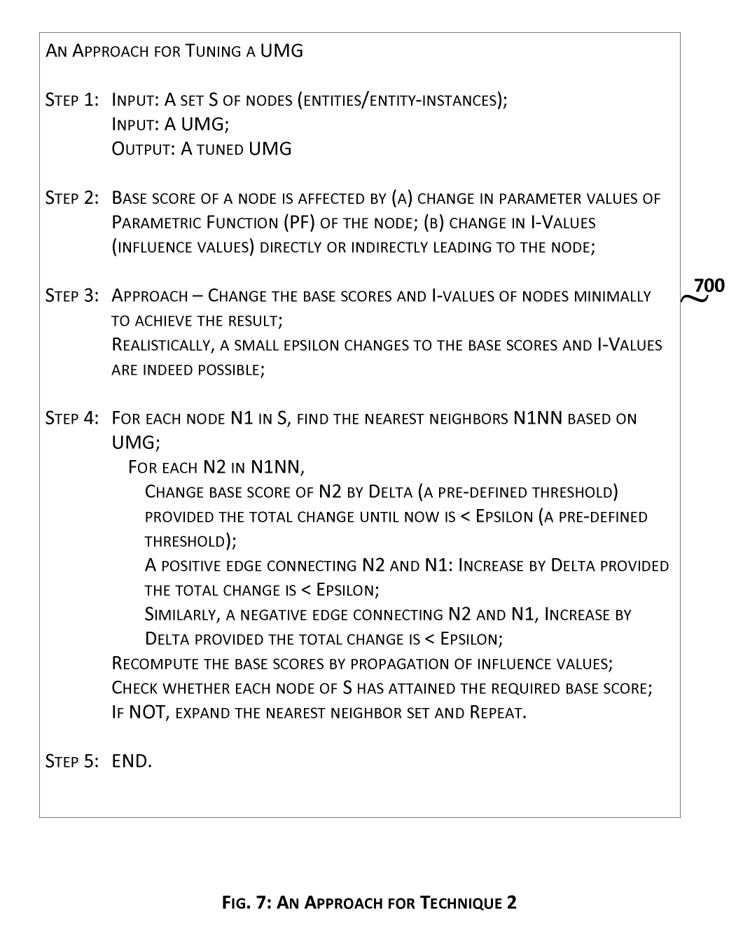

FIG. 7 provides an Approach for Technique 2.

### Means for an Approach for Tuning a UMG (700):

Step 1: Input: A set S of nodes (entities/entity-instances);

Input: A UMG;

Output: A tuned UMG

Step 2: Base score of a node is affected by (a) change in parameter values of Parametric Function (PF) of the node; (b) change in I-Values (influence values) directly or indirectly leading to the node;
Step 3: Approach—Change the base scores and I-values of nodes minimally to achieve the result;

Realistically, a small epsilon changes to the base scores and I-Values are indeed possible;

Step 4: For each node N1 in S, find the nearest neighbors N1NN based on UMG;

For each N2 in N1NN,
Change base score of N2 by Delta (a pre-defined threshold) provided the total change until now is <Epsilon (a pre-defined threshold);
A positive edge connecting N2 and N1: Increase by Delta provided the total change is <Epsilon;
Similarly, a negative edge connecting N2 and N1, Increase by Delta provided the total change is <Epsilon;

Recompute the base scores by propagation of influence values;

Check whether each node of S has attained the required base score;

If NOT, expand the nearest neighbor set and Repeat.

### Step 5: END.

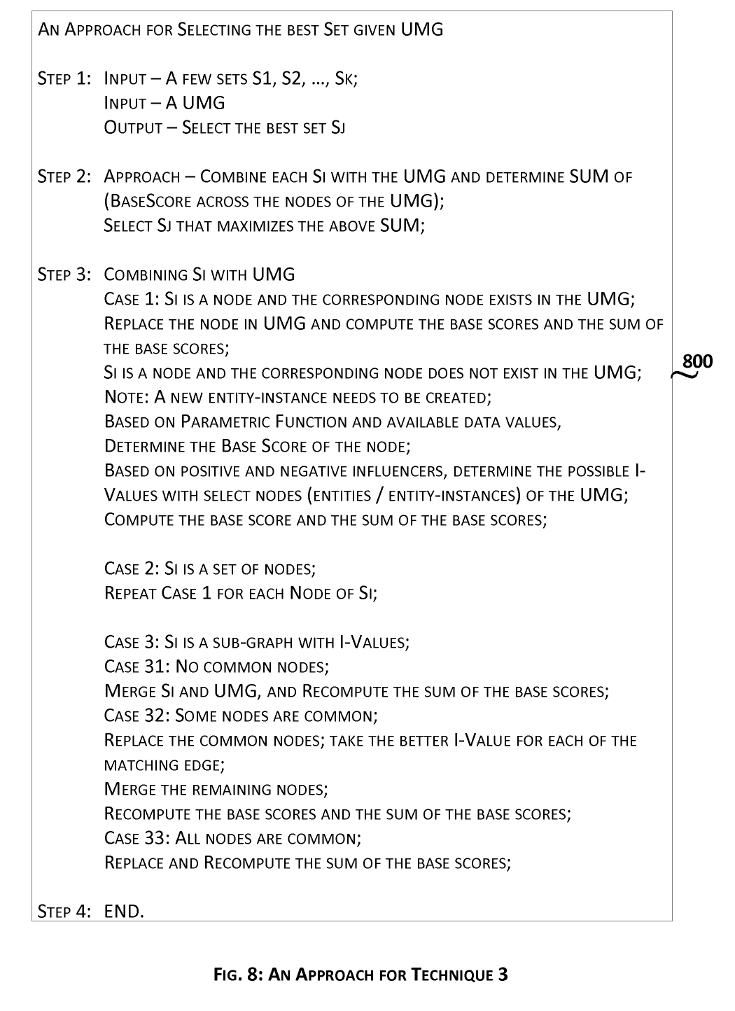

FIG. 8 provides an Approach for Technique 3.

Means for an Approach for Selecting the best Set given UMG (800):
Step 1: Input—A few sets S1, S2, . . . , Sk;

Input—A UMG

Output—Select the best set Sj

Step 2: Approach—Combine each Si with the UMG and determine SUM of (BaseScore across the nodes of the UMG);

Select Sj that maximizes the above SUM;

Step 3: Combining Si with UMG

Case 1: Si is a node and the corresponding node exists in the UMG;

Replace the node in UMG and compute the base scores and the sum of the base scores;

Si is a node and the corresponding node does not exist in the UMG;

Note: A new entity-instance needs to be created;

Based on Parametric Function and available data values,

Determine the Base Score of the node;

Based on positive and negative influencers, determine the possible I-Values with select nodes (entities/entity-instances) of the UMG;

Compute the base score and the sum of the base scores;

Case 2: Si is a set of nodes;

Repeat Case 1 for each Node of Si;

Case 3: Si is a sub-graph with I-Values;

Case 31: No common nodes;

Merge Si and UMG, and Recompute the sum of the base scores;

Case 32: Some nodes are common;

Replace the common nodes; take the better I-Value for each of the matching edge;

Merge the remaining nodes;

Recompute the base scores and the sum of the base scores;

Case 33: All nodes are common;

Replace and Recompute the sum of the base scores;

### Step 4: END.

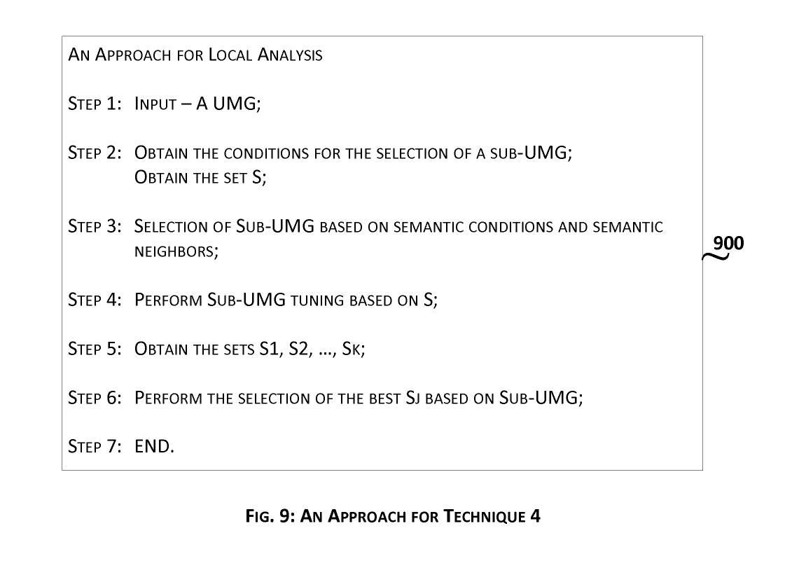

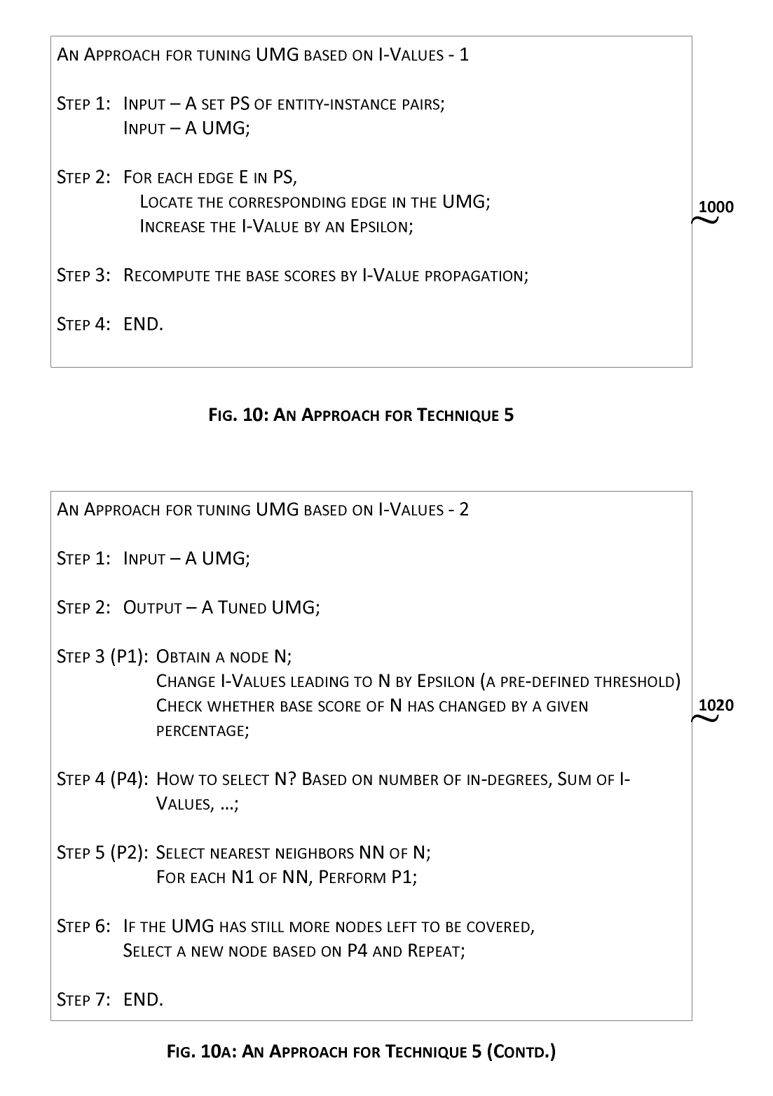

FIG. 9 provides an Approach for Technique 4.

### Means for an Approach for Local Analysis (900):

### Step 1: Input—A UMG;

Step 2: Obtain the conditions for the selection of a sub-UMG;

Obtain the set S;

Step 3: Selection of Sub-UMG based on semantic conditions and semantic neighbors;

For example, consider the entity FACULTY MEMBER; for each such entity, define semantic neighbors; and continue in the same manner; As an illustration, FACULTY MEMBER, all courses offered by FACULTY MEMBER (nearest neighbors NNs), STUDENTS who have enrolled for each course, LAB where FACULTY MEMBER is an investigator, FUNDS allocated to LAB, FACULTY MEMBER co-working in LAB, . . .

Step 4: Perform Sub-UMG tuning based on 5;
Step 5: Obtain the sets S1, S2, . . . , Sk;
Step 6: Perform the selection of the best Sj based on Sub-UMG;

### Step 7: END.

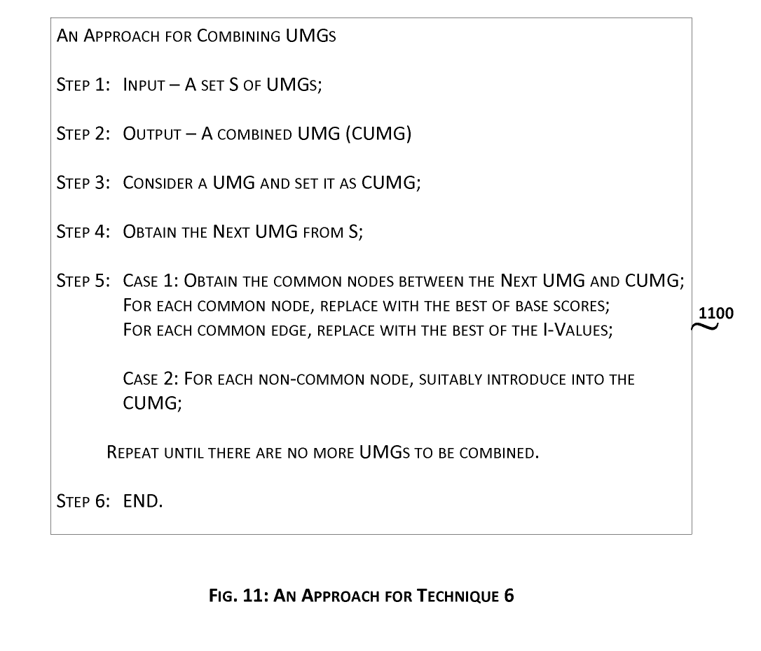

FIG. 10 provides an Approach for Technique 5.

Means for an Approach for tuning UMG based on I-Values—1 (1000):
Step 1: Input—A set PS of entity-instance pairs;

Input—A UMG;

Step 2: For each edge E in PS,

Locate the corresponding edge in the UMG;

Increase the I-Value by an Epsilon;

Step 3: Recompute the base scores by I-Value propagation;

### Step 4: END.

FIG. 10A provides additional information on Approach for Technique 5.

Means for an Approach for tuning UMG based on I-Values—2 (1020):

### Step 1: Input—A UMG;

### Step 2: Output—A Tuned UMG;

Step 3 (P1): Obtain a node N;

Change I-Values leading to N by Epsilon (a pre-defined threshold);

Check whether base score of N has changed by a given percentage;

Step 4 (P4): How to select N? Based on number of in-degrees, Sum of I-Values, . . . ;
Step 5 (P2): Select nearest neighbors NN of N;

For each N1 of NN, Perform P1;

Step 6: If the UMG has still more nodes left to be covered,

Select a new node based on P4 and Repeat;

### Step 7: END.

FIG. 11 provides an Approach for Technique 6.

### Means for an Approach for Combining UMGs (1100):

### Step 1: Input—A set S of UMGs;

Step 2: Output—A combined UMG (CUMG)

### Step 3: Consider a UMG and set it as CUMG;

Step 4: Obtain the Next UMG from S;
Step 5: Case 1: Obtain the common nodes between the Next UMG and CUMG;

For each common node, replace with the best of base scores;

For each common edge, replace with the best of the I-Values;

Case 2: For each non-common node, suitably introduce into the CUMG;

Repeat until there are no more UMGs to be combined.

### Step 6: END.

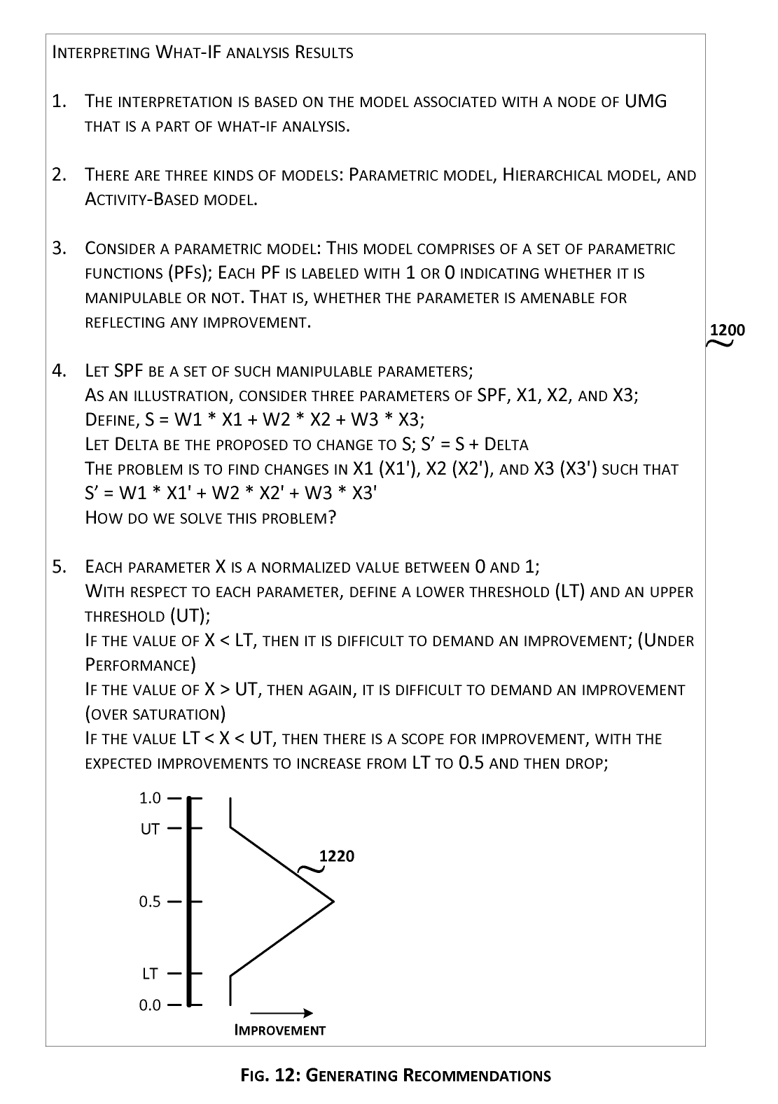

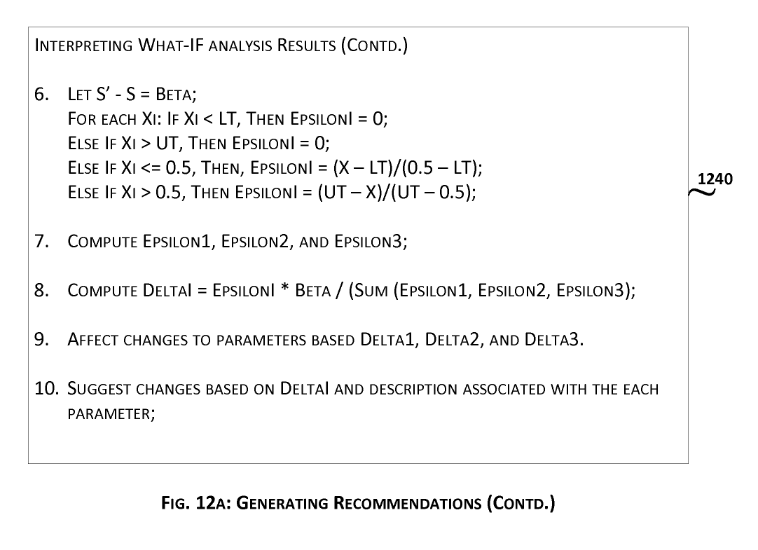

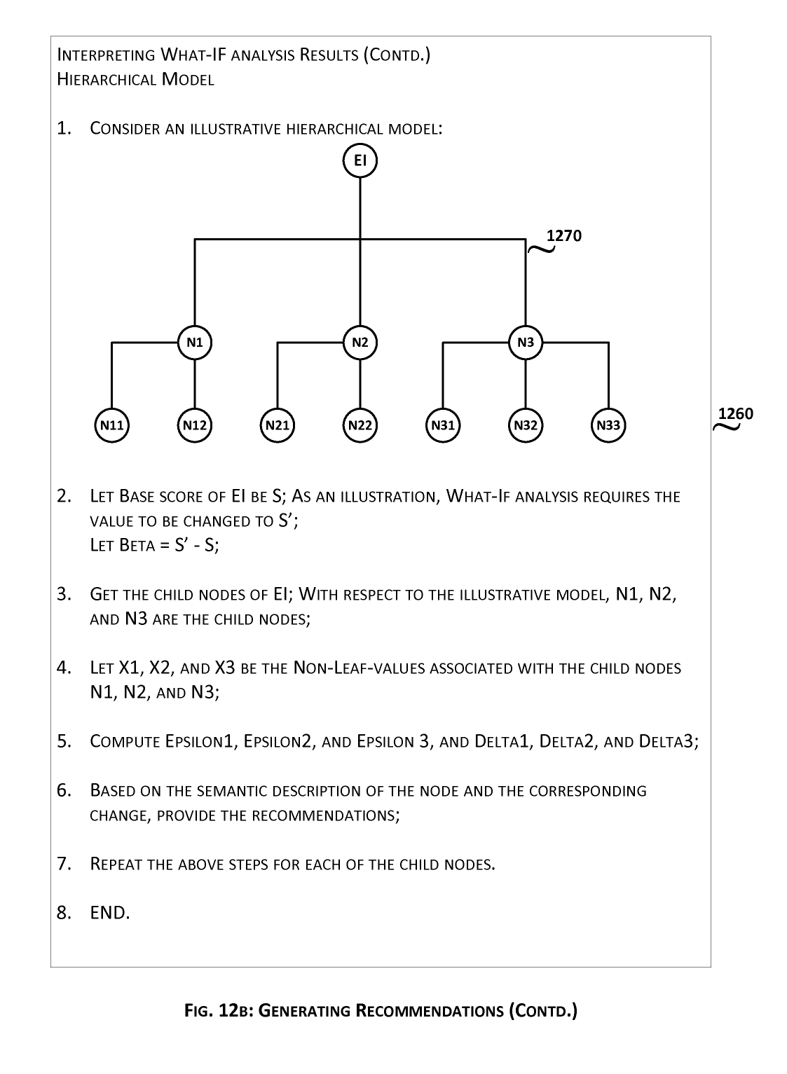

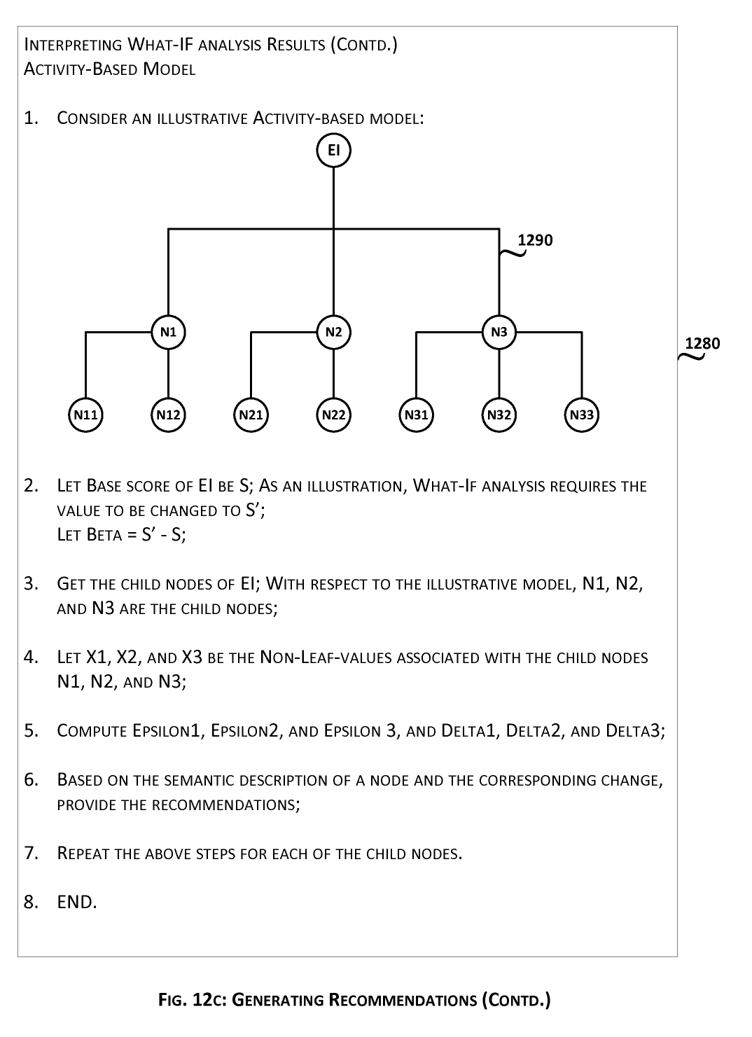

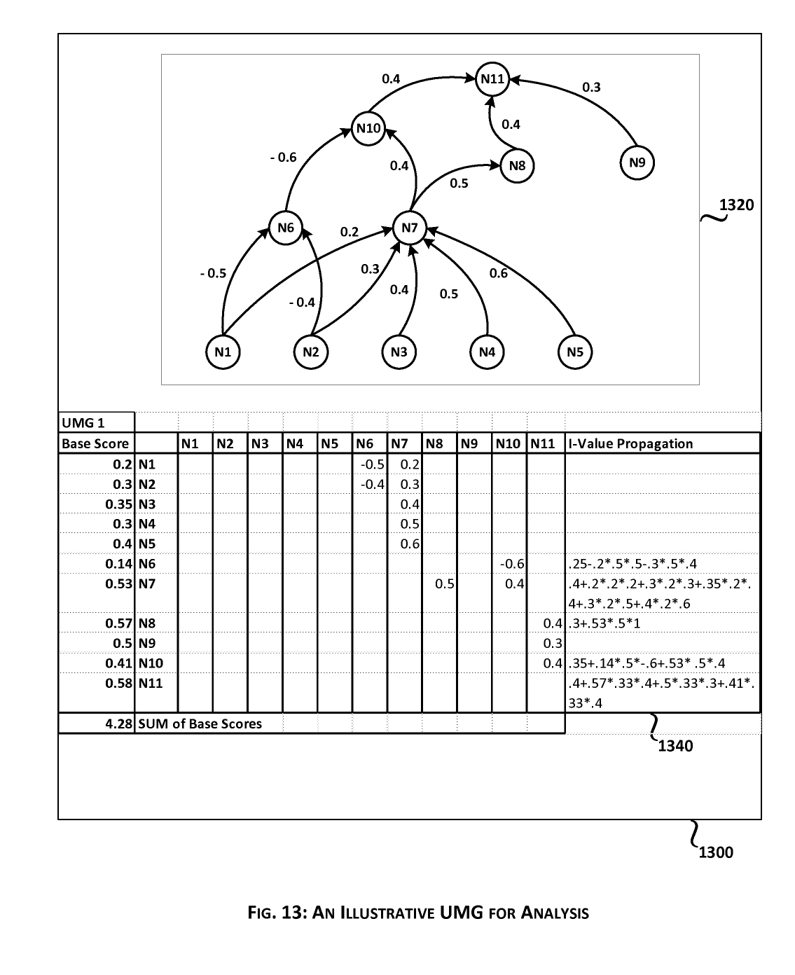

FIG. 12 provides an overview of Generating Recommendations.

Interpreting What-IF analysis Results (1200):

Means and an approach for generating recommendations based on Parametric Model:
1. The interpretation is based on the model associated with a node of UMG that is a part of what-if analysis.
2. There are three kinds of models: Parametric model, Hierarchical model, and Activity-Based model.
3. Consider a parametric model: This model comprises of a set of parametric functions (PFs); Each PF is labeled with 1 or 0 indicating whether it is manipulable or not. That is, whether the parameter is amenable for reflecting any improvement.
4. Let SPF be a set of such manipulable parameters;

As an illustration, consider three parameters of SPF, X1, X2, and X3;

Define,

S=W1*X1+W2*X2+W3*X3;

Let Delta be the proposed to change to S; S′=S+Delta

The problem is to find changes in X1 (X1′), X2 (X2′), and X3 (X3′) such that

S′=W1*X1′+W2*X2′+W3*X3′

How do we solve this problem?

5. Each parameter X is a normalized value between 0 and 1;

With respect to each parameter, define a lower threshold (LT) and an upper threshold (UT) (1220);

If the value of X<LT, then it is difficult to demand an improvement; (Under Performance)

If the value of X>UT, then again, it is difficult to demand an improvement (Over Saturation)

If the value LT<X<UT, then there is a scope for improvement, with the expected improvements to increase from LT to 0.5 and then drop;

FIG. 12A provides additional information related to Generating of Recommendations.

Interpreting What-IF analysis Results (Contd.) (1240):
Means and an approach for generating recommendations based on Parametric Model (Contd.):

### 6. Let S′−S=Beta;

For each Xi: If Xi<LT, Then Epsilon1=0;

Else If Xi>UT, Then Epsilon1=0;

Else If Xi<=0.5, Then, Epsilon1=(X−LT)/(0.5−LT);

Else If Xi>0.5, Then Epsilon1=(UT−X)/(UT−0.5);

### 7. Compute Epsilon1, Epsilon2, and Epsilon3;

### 8. Compute Delta1=Epsilon1*Beta/(Sum (Epsilon1, Epsilon2, Epsilon3);

9. Affect changes to parameters based Delta1, Delta2, and Delta3.
10. Suggest changes based on Delta1 and description associated with the each parameter;

FIG. 12B provides more information related to Generating of Recommendations.

Interpreting What-IF analysis Results (Contd.) (1260):
Means and an approach for generating recommendations based on Hierarchical Model:
1. Consider an illustrative hierarchical model (1270):
2. Let Base score of E1 be S; As an illustration, What-If analysis requires the value to be changed to S′;

Let Beta=S′−S;

3. Get the child nodes of E1; With respect to the illustrative model, N1, N2, and N3 are the child nodes;
4. Let X1, X2, and X3 be the Non-Leaf-values associated with the child nodes N1, N2, and N3;

### 5. Compute Epsilon1, Epsilon2, and Epsilon 3, and Delta1, Delta2, and Delta3;

6. Based on the semantic description of a node and the corresponding change, provide the recommendations;
7. Repeat the above steps for each of the child nodes.

### 8. END.

FIG. 12C provides further more information related to Generating of Recommendations.

Interpreting What-IF analysis Results (Contd.) (1280):
Means and an approach for generating recommendations based on Activity-Based Model:
1. Consider an illustrative Activity-based model (1290):
2. Let Base score of E1 be S; As an illustration, What-If analysis requires the value to be changed to S′;

Let Beta=S′−S;

3. Get the child nodes of E1; With respect to the illustrative model, N1, N2, and N3 are the child nodes;
4. Let X1, X2, and X3 be the Non-Leaf-values associated with the child nodes N1, N2, and N3;

### 5. Compute Epsilon1, Epsilon2, and Epsilon 3, and Delta1, Delta2, and Delta3;

6. Based on the semantic description of a node and the corresponding change, provide the recommendations;
7. Repeat the above steps for each of the child nodes.

### 8. END.

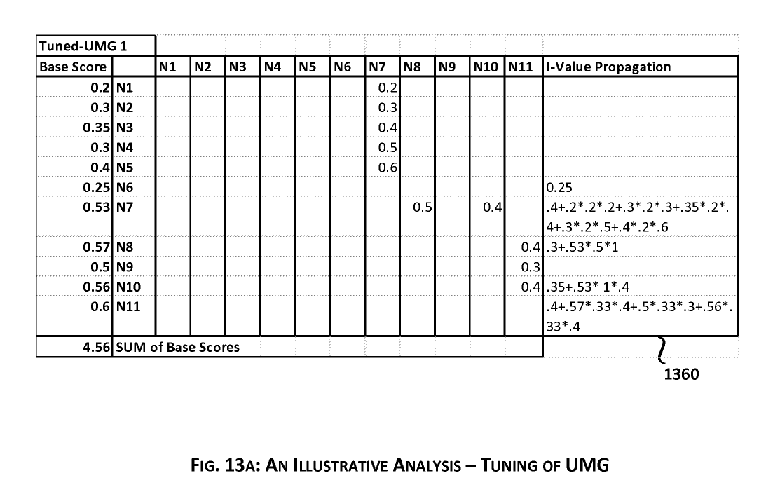

FIG. 13 provides an illustrative UMG for Analysis.

The illustrated UMG (1300) is shown in two forms: A graph based depiction (1320) displays how the various nodes (that stand for entities/entity-instances) N1, N2, . . . , N11 are interconnected; further, the edges are indicated with the illustrative influence values that are a value between −1 and +1. An equivalent representation is in the form of adjacency matrix (1340). In this representation, the element values depict the influence values as shown. Further, the base score associated with each of the nodes is also indicated under the column “Base Score.” The depicted UMG is in its stable form after the influence values have been propagated. An illustrative propagation is shown wherein the influence values of the child nodes along with base scores are used in arriving at the updated base score of a parent node.

FIG. 13A provides an illustrative Analysis Result related to Tuning of UMG. 1360 depicts the result of the illustrative analysis. In tuning, an attempt is made to reduce the negative influence values associated with N1-N6, N2-N6, and N6-N10. The base scores are appropriately recomputed based on the changed influence values leading to the UMG that is better (operationally, more efficient) as depicted by the SUM of the base scores (4.56 as compared with 4.28).

Thus, a system and method for what-if analysis based on a university model graph is disclosed. Although the present invention has been described particularly with reference to the figures, it will be apparent to one of the ordinary skill in the art that the present invention may appear in any number of systems that provide for what-if analysis of influence based structural representation. It is further contemplated that many changes and modifications may be made by one of ordinary skill in the art without departing from the spirit and scope of the present invention.

What is claimed is:

1. A system for the what-if analysis of a plurality of what-if requests based on a university model graph (UMG) of a university to generate a plurality of recommendations based on a plurality of assessments and a plurality of influence values contained in a university model graph database to help in undertaking introspective analysis of said university, said university having a plurality of entities and a plurality of entity-instances,
wherein each of said plurality of entity-instances is an instance of an entity of said plurality of entities, and said university model graph having a plurality of models, a plurality of abstract nodes, a plurality of nodes, a plurality of abstract edges, a plurality of semi-abstract edges, and a plurality of edges,
with each abstract node of said plurality of abstract nodes corresponding to an entity of said plurality of entities,
each node of said plurality of nodes corresponding to an entity-instance of said plurality of entity-instances, and
each abstract node of said plurality of abstract nodes is associated with a model of said plurality of models, and
a node of said plurality of nodes is connected to an abstract node of said plurality of abstract nodes through an abstract edge of said plurality of abstract edges, wherein said node represents an instance of an entity associated with said abstract node and said node is associated with an instantiated model and a base score, wherein said instantiated model is based on a model associated with said abstract node, and said base score is computed based on said instantiated model and is a value between 0 and 1,
a source abstract node of said plurality of abstract nodes is connected to a destination abstract node of said plurality of abstract nodes by a directed abstract edge of said plurality of abstract edges and said directed abstract edge is associated with an entity influence value of said plurality of influence values, wherein said entity influence value is a value between −1 and +1;
a source node of said plurality of nodes is connected to a destination node of said plurality of nodes by a directed edge of said plurality of edges and said directed edge is associated with an influence value of said plurality influence values, wherein said influence value is a value between −1 and +1;
a source node of said plurality of nodes is connected to a destination abstract node of said plurality of abstract nodes by a directed semi-abstract edge of said plurality of semi-abstract edges and said directed semi-abstract edge is associated with an entity-instance-entity-influence value of said plurality influence values, wherein said entity-instance-entity-influence value is a value between −1 and +1; and
a source abstract node of said plurality of abstract nodes is connected to a destination node of said plurality of nodes by a directed semi-abstract edge of said plurality of semi-abstract edges and said directed semi-abstract edge is associated with an entity-entity-instance-influence value of said plurality influence values, wherein said entity-entity-instance-influence value is a value between −1 and +1,
said system comprising,
means for deriving of a revised optimized university model graph based on a what-if request of said plurality of what-if requests and said UMG; and
means for generating of a recommendation of said plurality of recommendations based on said revised optimized university model graph;
wherein said means for deriving of said revised optimized university model graph further comprises of:
means for generating of an optimal sub-UMG based on said UMG and assigning of said optimal sub-UMG as said revised optimized university model graph;
means for generating of a tuned UMG based on said UMG and a plurality of select nodes, wherein each select node of said plurality of select nodes is a part of said plurality of abstract nodes or a part of said plurality of bodes, and is associated with an expected base score, and assigning of said tuned UMG as said revised optimized university model graph;
means for selecting of a best set of a plurality of sets based on said UMG, wherein each set of said plurality of sets comprises of a plurality of selected abstract nodes of said plurality of abstract nodes and a plurality of selected nodes of said plurality of nodes, and assigning of said best set as said revised optimized university model graph;
means for local analysis of said UMG to generate a local sub-UMG;
means for generating of a tuned sub-UMG based on said local sub-UMG, and assigning of said tuned sub-UMG as said revised optimized university model graph;
means for selecting of a local best set of a plurality of local sets based on said local sub-UMG, wherein each set of said plurality of local sets comprises of a plurality of selected abstract nodes of said plurality of abstract nodes and a plurality of selected nodes of said plurality of nodes, and assigning of said local best set as said revised optimized university model graph;
means for generating of an influence tuned UMG based on said UMG and a plurality of select node pairs, wherein a node pair of said plurality of node pairs comprises of a node 1 of said node pair is a part of said plurality of abstract nodes or said plurality of nodes, a node 2 of said node pair is a part of said plurality of abstract nodes or said plurality of nodes, and assigning of said influence tuned UMG as said revised optimized university model graph;
means for generating of an influence tuned UMG 2 based on said UMG, and assigning of said influence tuned UMG 2 as said revised optimized university model graph; and
means for combining of a plurality of additional university model graphs and said UMG to generate a combined UMG, and assigning of said combined UMG as said revised optimized university model graph.
(REFER TO FIGS. 1-3 and FIG. 5)

2. The system of claim 1, wherein said means for generating of said optimal sub-UMG further comprises of:
means obtaining of a plurality of nodes associated with said optimal sub-UMG;
means for selecting of a node of said plurality of nodes;
means for computing of an aggregated incoming negative influence value based on said node;
means for computing of a number of nodes 1 based on said node, wherein said number of nodes 1 is based on a plurality of incoming negative influencing edges of said plurality of edges that collectively influence said aggregated incoming negative influence value;
means for computing of an aggregated outgoing negative influence value based on said node;
means for computing of a number of nodes 2 based on said node, wherein said number of nodes 2 is based on a plurality of outgoing negative influencing edges of said plurality of edges that collectively get influenced by said aggregated outgoing negative influence value;
means for computing of an aggregated incoming positive influence value based on said node;
means for computing of a number of nodes 3 based on said node, wherein said number of nodes 3 is based on a plurality of incoming positive influencing edges of said plurality of edges that collectively influence said aggregated incoming positive influence value;
means for computing of an aggregated outgoing positive influence value based on said node;
means for computing of a number of nodes 4 based on said node, wherein said number of nodes 4 is based on a plurality of outgoing positive influencing edges of said plurality of edges that collectively get influenced by said aggregated outgoing positive influence value;
means for incrementing of an influence value associated with each of said plurality of outgoing positive influencing edges based on said aggregated outgoing negative influence value and said number of nodes 4;
means for zeroing of an influence value associated with each of said plurality of outgoing negative influencing edges;
means for incrementing of each of said plurality of incoming positive influencing edges based on said aggregated incoming negative influence value and said number of nodes 3;
means for zeroing of an influence value associated with each of said plurality of incoming negative influencing edges;
means for computing of an alpha aggregated incoming positive influence value based on said aggregated incoming positive influence value and a pre-defined threshold;
means for incrementing of an influence value associated with each of said plurality of outgoing negative influencing edges based on said alpha aggregated incoming positive influence value and said number of nodes 2;
means for incrementing of an influence value associated with each of said plurality of incoming positive influencing edges based on said alpha aggregated incoming positive influence value and said number of nodes 3;
means for computing of a beta aggregated outgoing positive influence value based on said aggregated outgoing positive influence value and a pre-defined threshold;
means for incrementing of an influence value associated with each of said plurality of incoming negative influencing edges based on said beta aggregated outgoing positive influence value and said number of nodes 1;
means for incrementing of an influence value associated with each of said plurality of outgoing positive influencing edges based on said beta aggregated outgoing positive influence value and said number of nodes 4; and
means for removing of said node.
(REFER TO FIG. 6 and FIG. 6A)

3. The system of claim 1, wherein said means for generating of said tuned UMG further comprises of:
means for obtaining of a node of said plurality of select nodes;
means for determining of a plurality of nearest neighbor nodes of said node based on said tuned UMG;
means for obtaining a node 2 of said plurality of nearest neighbor nodes;
means for changing of a base score of said node 2 by a pre-defined threshold resulting in a total change in said base score, wherein said total change is less than a second pre-defined threshold;
means for obtaining a positive edge connecting said node 2 and said node;
means for changing of an influence value associated with said positive edge by said pre-defined threshold resulting in a total change in said influence value, wherein said total change is less than said second pre-defined threshold;
means for obtaining a negative edge connecting said node 2 and said node;
means for changing of an influence value associated with said negative edge by said pre-defined threshold resulting in a total change in said influence value, wherein said total change is less than said second pre-defined threshold;
means for recomputing of a base score associated with each node of said plurality of select nodes; and
means for expanding of said plurality of nearest neighbor nodes.
(REFER TO FIG. 7)

4. The system of claim 1, wherein said means for selecting of said best set further comprises of:
means for obtaining of a set of said plurality of sets;
means for obtaining of a node of said set;
means for replacing of said node in said UMG;
means for adding of said node to said UMG, determining of a plurality of influence values associated with said node, and determining of a base score of said node;
means for obtaining of a plurality of nodes of said set;
means for replacing of a node of said plurality of nodes in said UMG;
means for adding of a node of said plurality of nodes to said UMG;
means for obtaining of a sub-graph of said plurality of sets;
means for determining of a plurality of common nodes based on said sub-graph and said UMG;
means for replacing said plurality of common nodes in said UMG;
means for determining of a plurality of common edges based on said sub-graph and said UMG;
means for obtaining of a common edge 1 of said plurality of common edges, wherein said common edge 1 is associated with an influence value 1;
means for determining of a common edge 2 of said UMG, wherein said common edge 2 corresponds with said common edge 1 and is associated with an influence value 2;
means for associating an influence value with said common edge 2 based on said influence value 1 and said influence value 2;
means for merging of said sub-graph with said UMG;
means for recomputing of a plurality of base scores based on said UMG, wherein each of said plurality of base scores is associated with a node of said UMG;
means for computing of a sum base score based on said plurality of base scores;
means for computing of a plurality of sum base scores, wherein each of said plurality of sum base scores is associated with a set of said plurality of sets; and
means for selecting of said best set based on said plurality of sets and said plurality of sum base scores.
(REFER TO FIG. 8)

5. The system of claim 1, wherein said means for local analysis of said UMG further comprises of:
means for obtaining of a node of said local sub-UMG;
means for obtaining of a plurality of semantic conditions;
means for determining of a plurality of semantic neighbors based on said node and said UMG; and
means for adding of said plurality of semantic neighbors to said local sub-UMG.
(REFER TO FIG. 9)

6. The system of claim 1, wherein said means for generating of said influence tuned UMG further comprises of:
means for obtaining a node pair of said plurality of select node pairs, wherein said node pair is associated with an edge;
means for locating of an edge 1 based on said influence tuned UMG, wherein said edge 1 corresponds with said edge;
means for obtaining of an influence value associated with said edge 1;
means for increasing of said influence value based on a pre-defined threshold; and
means for recomputing of a plurality of base scores based on said influence tuned UMG, wherein each of said plurality of base scores is associated with a node of said influence tuned UMG.
(REFER TO FIG. 10)

7. The system of claim 1, wherein said means for generating of said influence tuned UMG 2 further comprises of:
means for obtaining of a node of said influence tuned UMG 2;
means for obtaining of a node 2 based on said influence tuned UMG 2, wherein an edge connects said node 2 and said node;
means for changing of an influence value associated with said edge based on a pre-defined threshold;
means for recomputing a base score of said node to determine a percentage change in said base score;
means for selecting of said node based on the conditions comprising of the number of in-degrees of said node, and the sum of influence values associated with said node;
means for selecting a plurality of nearest neighbors of said node based on said influence tuned UMG 2; and
means for changing of an influence value associated with each of said plurality of nearest neighbors based on a pre-defined threshold.
(REFER TO FIG. 10A)

8. The system of claim 1, wherein said means for combining of said plurality of additional university model graphs further comprises of:
means for obtaining of a next university model graph based on said plurality of additional university model graphs;
means for determining of a plurality of common nodes based on said next university model graph and said combined UMG;
means for determining of a plurality of common edges based on said next university model graph and said combined UMG;
means for replacing of a base score of a node of said plurality of common nodes based on the base score of said node in said next university model graph and the base score of said node in said combined UMG;
means for replacing of an influence value of an edge of said plurality of common edges based on the influence value of said edge in said next university model graph and the influence value of said edge in said combined UMG;
means for determining of a plurality of non-common nodes based on said next university model graph and said combined UMG; and
means for adding of each of said plurality of non-common nodes into said combined UMG.
(REFER TO FIG. 11)

9. The system of claim 1, wherein said means for generating of said recommendation further comprises of:
means for obtaining a node of said UMG;
means for obtaining of a node 1 from said revised optimized university model graph, wherein said node 1 corresponds with said node;
means for determining of a base score associated with said node;
means for determining of a base score 1 associated with said node 1;
means for determining of a parametric model associated with said node 1;
means for determining of a plurality of manipulable parameters of said parametric model;
means for determining a parameter of said plurality of manipulable parameters;
means for determining a lower threshold associated with said parameter;
means for determining of an upper threshold associated with said parameter;
means for determining of a value associated with said parameter based on said UMG;
means for computing of an epsilon value associated with said parameter based on said lower threshold, said upper threshold, and said value;
means for computing of a plurality of epsilon values, wherein each of said plurality of epsilon values is associated with a manipulable parameter of said plurality of manipulable parameters;
means for computing of a beta value based said base score 1 and said base score;
means for computing of a plurality of delta values based on said plurality of epsilon values and said beta value;
means for affecting a change to said parameter based on a delta value of said plurality of delta values, wherein said delta value is associated with said parameter;
means for obtaining of a semantic description associated with said parameter; and
means for providing of said recommendation based on said delta value, said change, and said semantic description.
(REFER TO FIG. 12 and FIG. 12A)

10. The system of claim 9, wherein said means further comprises of:
means for obtaining a node of said UMG;
means for obtaining of a node 1 from said revised optimized university model graph, wherein said node 1 corresponds with said node;
means for determining of a base score associated with said node;
means for determining of a base score 1 associated with said node 1;
means for computing of a beta value based said base score 1 and said base score;
means for determining of a hierarchical model associated with said node 1;
means for determining of a plurality of child nodes of said node 1 based on said hierarchical model;
means for determining of a plurality of non-leaf-values associated with said plurality of child nodes;
means for obtaining of a plurality of lower thresholds associated with said plurality of child nodes;
means for obtaining of a plurality of upper thresholds associated with said plurality of child nodes;
means for computing of a plurality of epsilon values based on said plurality of non-leaf values, said plurality of lower thresholds, and said plurality of upper thresholds;
means for computing of a plurality of delta values based on said beta value and said plurality of epsilon values;
means for affecting a change to a child node of said plurality of child nodes based on a delta value of said plurality of delta values, wherein said delta value is associated with said child node;
means for obtaining of a semantic description associated with said child node; and
means for providing of said recommendation based on said delta value, said change, and said semantic description.
(REFER TO FIG. 12B)

11. The system of claim 9, wherein said means further comprises of:
means for obtaining a node of said UMG;
means for obtaining of a node 1 from said revised optimized university model graph, wherein said node 1 corresponds with said node;
means for determining of a base score associated with said node;
means for determining of a base score 1 associated with said node 1;
means for computing of a beta value based said base score 1 and said base score;
means for determining of an activity based model associated with said node 1;
means for determining of a plurality of child nodes of said node 1 based on said activity based model;
means for determining of a plurality of non-leaf-values associated with said plurality of child nodes;
means for obtaining of a plurality of lower thresholds associated with said plurality of child nodes;
means for obtaining of a plurality of upper thresholds associated with said plurality of child nodes;
means for computing of a plurality of epsilon values based on said plurality of non-leaf values, said plurality of lower thresholds, and said plurality of upper thresholds;
means for computing of a plurality of delta values based on said beta value and said plurality of epsilon values;
means for affecting a change to a child node of said plurality of child nodes based on a delta value of said plurality of delta values, wherein said delta value is associated with said child node;
means for obtaining of a semantic description associated with said child node; and
means for providing of said recommendation based on said delta value, said change, and said semantic description.
(REFER TO FIG. 12C)
